(19) United States
(12) Patent Application Publication
(10) Pub. No.: US 2022/0367889 A1
(43) Pub. Date: Nov. 17, 2022

(54) FUEL CELL

(71) Applicant: TOYOTA JIDOSHA KABUSHIKI KAISHA, Toyota-shi (JP)

(72) Inventor: Nobuaki NONOYAMA, Chiryu-shi (JP)

(73) Assignee: TOYOTA JIDOSHA KABUSHIKI KAISHA, Toyota-shi (JP)

(21) Appl. No.: 17/662,772

(22) Filed: May 10, 2022

(30) Foreign Application Priority Data
May 14, 2021 (JP) 2021-082272

(51) Int. Cl. H01M 8/04007; H01M 8/04014; H01M 8/04029

(52) U.S. Cl. CPC H01M 8/04074; H01M 8/04014; H01M 8/04029

(57) ABSTRACT

To provide a fuel cell in which the gas sealing property between the unit fuel cells is high and the sectional area of the refrigerant flow path is large. A fuel cell comprising: unit fuel cells adjacent to each other, a cooling plate, and a gasket, wherein the cooling plate is disposed between the adjacent unit fuel cells; wherein the cooling plate is a corrugated plate comprising concave grooves configured to function as a refrigerant flow path; wherein the gasket comprises a first convexity having a height larger than a thickness of the cooling plate, and the gasket seals manifolds of the adjacent unit fuel cells; and wherein, at least at a part of a side portion of the first convexity, the gasket comprises a second convexity comprising a convexity in the same direction as the first convexity.

### CROSS-REFERENCE TO RELATED APPLICATION

This application claims priority to Japanese Patent Application No. 2021-082272 filed on May 14, 2021, which is incorporated herein by reference in its entirety.

### TECHNICAL FIELD

The disclosure relates to a fuel cell.

### BACKGROUND

A fuel cell (FC) is a power generation device which is composed of a single unit fuel cell (hereinafter, it may be referred to as “cell”) or a fuel cell stack composed of stacked unit fuel cells (hereinafter, it may be referred to as “stack”) and which generates electrical energy by electrochemical reaction between fuel gas (e.g., hydrogen) and oxidant gas (e.g., oxygen). In many cases, the fuel gas and oxidant gas actually supplied to the fuel cell, are mixtures with gases that do not contribute to oxidation and reduction. Especially, the oxidant gas is often air containing oxygen.

Hereinafter, fuel gas and oxidant gas may be collectively and simply referred to as “reaction gas” or “gas”. Also, a single unit fuel cell and a fuel cell stack composed of stacked unit cells may be referred to as “fuel cell”.

Various kinds of fuel cell techniques were proposed.

For example, Patent Literature 1 discloses a cooling plate (a corrugated fin) which is disposed between adjacent cells and formed of a corrugated plate having concave grooves that function as a cooling gas flow path.

Patent Literature 2 discloses an air-cooled metal separator which does not require cooling water.

Patent Literature 3 discloses a stack for fuel cells which has improved cooling efficiency, and a fuel cell system including the stack.

Patent Literature 1: Japanese Patent Application Laid-Open (JP-A) No. 2020-126782

Patent Literature 2: Japanese translation of PCT International Application No. 2013-500567

Patent Literature 3: JP-A No. 2006-210351

The unit fuel cells of a fuel cell generate heat in electrochemical reaction. In some fuel cells, a cooling plate is disposed between adjacent unit fuel cells and between the side and side plate portion of the adjacent cells, and the unit fuel cells are cooled down by the cooling plate to prevent that the fuel cell temperature reaches an excessively high temperature. In addition to water-cooling, air-cooling has been studied as another cooling method. In this case, since the air is used as the refrigerant and has smaller heat capacity than water, the volumetric flow rate of the cooling medium is tens of times larger than that of water. Accordingly, it is necessary to make a refrigerant flow path much deeper than the case of water-cooling.

In Patent Literature 1, there is no description of gaskets and seals. However, it can be read from FIG. 2 of Patent Literature 1 that the end portions of the corrugated fin forming the cooling gas flow path reach the cell end portions. In this case, at the cell end portions, two kinds of gaskets are necessary to seal the boundary between the corrugated fin and the first cell and the boundary between the corrugated fin and the second cell. As a result, the numbers of components increases. In addition, assembly of the components is expected to be more cumbersome. Accordingly, if the corrugated fin end portions is prevented from reaching the cell end portions, only one kind of gasket is needed. To increase the sectional area of the cooling gas flow path, however, it is necessary to increase the folding pitch of the corrugated fin. If the height of the gasket is increased according to the pitch, the gasket is likely to deform (for example, the gasket is likely to wobble when load is applied), distort or bend, thereby leading a reduction in sealing properties.

### SUMMARY

The present disclosure was achieved in light of the above circumstances. An object of the present disclosure is to provide a fuel cell in which the gas sealing property between the unit fuel cells is high and the sectional area of the refrigerant flow path is large.

The fuel cell of the present disclosure is a fuel cell comprising:
unit fuel cells adjacent to each other,
a cooling plate, and
a gasket,

wherein the cooling plate is disposed between the adjacent unit fuel cells;

wherein the cooling plate is a corrugated plate comprising concave grooves configured to function as a refrigerant flow path;

wherein the gasket comprises a first convexity having a height larger than a thickness of the cooling plate, and the gasket seals manifolds of the adjacent unit fuel cells; and

wherein, at least at a part of a side portion of the first convexity, the gasket comprises a second convexity comprising a convexity in the same direction as the first convexity.

The height of the second convexity may be equal to or lower than the height of the first convexity.

Cooling water or air may flow through the refrigerant flow path.

In the fuel cell of the present disclosure, the gas sealing property between the unit fuel cells is high and the sectional area of the refrigerant flow path is large

### BRIEF DESCRIPTION OF THE DRAWINGS

In the accompanying drawings,

FIG. 1 is an exploded perspective view of an example of a part of the fuel cell of the present disclosure;

FIG. 2 is a plan view of an example of the fuel cell of the present disclosure; and

FIG. 3 is a sectional view of the fuel cell shown in FIG. 2 along the line E-E.

### DETAILED DESCRIPTION

The fuel cell of the present disclosure is a fuel cell comprising:
unit fuel cells adjacent to each other,
a cooling plate, and
a gasket,

wherein the cooling plate is disposed between the adjacent unit fuel cells;

wherein the cooling plate is a corrugated plate comprising concave grooves configured to function as a refrigerant flow path;

wherein the gasket comprises a first convexity having a height larger than a thickness of the cooling plate, and the gasket seals manifolds of the adjacent unit fuel cells; and

wherein, at least at a part of a side portion of the first convexity, the gasket comprises a second convexity comprising a convexity in the same direction as the first convexity.

In air-cooling, the volumetric flow rate of the cooling component (the cooling plate) is tens of times larger than water-cooling. Accordingly, it is necessary to make the refrigerant flow path much deeper than water-cooling. When the cooling component is in contact with the reaction system, corrosion resistance is necessary. Accordingly, heavy SUS or Ti has been surface-treated and used at high cost, or a separator formed by cutting deep grooves in carbon, has been used.

According to the present disclosure, the bipolar plate of the unit fuel cells adjacent to each other, has a three-layered structure consisting of the separator of one of the unit fuel cells, the cooling plate, and the separator of the other unit fuel cell. Accordingly, separator formation by forming deep grooves by press-molding, is unnecessary. Even in the case where it is necessary to provide large cooling space between the cells and thus the gasket is likely to deform (such as air-cooling), the reliability of the sealing between the cells is increased, and integral fuel cell formation is possible. Accordingly, an increase in the number of components is suppressed, and the cumbersomeness of the assembly is reduced. Due to the increased sealing reliability, the corrosion resistance required of the cooling plate is lowered. Accordingly, a low-cost material that is easy to bend, such as aluminum, can be used as the material for the cooling plate.

The fuel cell includes the unit fuel cells adjacent to each other, the cooling plate disposed between the adjacent unit fuel cells, and the gasket.

The fuel cell is a fuel cell stack composed of stacked unit fuel cells.

The number of the stacked unit fuel cells is not particularly limited. For example, 2 to several hundred unit fuel cells may be stacked; 2 to 600 unit fuel cells may be stacked; or 2 to 200 unit fuel cells may be stacked.

The fuel cell stack may include an end plate at both stacking-direction ends of each unit fuel cell, a collector plate, a pressure plate and the like.

Each unit fuel cell may include a membrane electrode gas diffusion layer assembly (MEGA). Each unit fuel cell may include first and second separators sandwiching the membrane electrode gas diffusion layer assembly.

The membrane electrode gas diffusion layer assembly includes a first gas diffusion layer, a first catalyst layer, an electrolyte membrane, a second catalyst layer and a second gas diffusion layer in this order.

More specifically, the membrane electrode gas diffusion layer assembly includes an anode-side gas diffusion layer, an anode catalyst layer, an electrolyte membrane, a cathode catalyst layer and a cathode-side gas diffusion layer in this order.

One of the first and second catalyst layers is the cathode catalyst layer, and the other is the anode catalyst layer.

The cathode (oxidant electrode) includes the cathode catalyst layer and the cathode-side gas diffusion layer.

The anode (fuel electrode) includes the anode catalyst layer and the anode-side gas diffusion layer.

The first catalyst layer and the second catalyst layer are collectively referred to as “catalyst layer”. The cathode catalyst layer and the anode catalyst layer are collectively referred to as “catalyst layer”.

One of the first gas diffusion layer and the second gas diffusion layer is the cathode-side gas diffusion layer, and the other is the anode-side gas diffusion layer.

The first gas diffusion layer is the cathode-side gas diffusion layer when the first catalyst layer is the cathode catalyst layer. The first gas diffusion layer is the anode-side gas diffusion layer when the first catalyst layer is the anode catalyst layer.

The second gas diffusion layer is the cathode-side gas diffusion layer when the second catalyst layer is the cathode catalyst layer. The second gas diffusion layer is the anode-side gas diffusion layer when the second catalyst layer is the anode catalyst layer.

The first gas diffusion layer and the second gas diffusion layer are collectively referred to as “gas diffusion layer” or “diffusion layer”. The cathode-side gas diffusion layer and the anode-side gas diffusion layer are collectively referred to as “gas diffusion layer” or “diffusion layer”.

The gas diffusion layer may be a gas-permeable electroconductive member or the like.

As the electroconductive member, examples include, but are not limited to, a porous carbon material such as carbon cloth and carbon paper, and a porous metal material such as metal mesh and foam metal.

The fuel cell may include a microporous layer (MPL) between the catalyst layer and the gas diffusion layer. The microporous layer may contain a mixture of a water repellent resin such as PTFE and an electroconductive material such as carbon black.

The electrolyte membrane may be a solid polymer electrolyte membrane. As the solid polymer electrolyte membrane, examples include, but are not limited to, a hydrocarbon electrolyte membrane and a fluorine electrolyte membrane such as a thin, moisture-containing perfluorosulfonic acid membrane. The electrolyte membrane may be a Nafion membrane (manufactured by DuPont Co., Ltd.), for example.

One of the first separator and the second separator is the cathode-side separator, and the other is the anode-side separator.

The first separator is the cathode-side separator when the first catalyst layer is the cathode catalyst layer. The first separator is the anode-side separator when the first catalyst layer is the anode catalyst layer.

The second separator is the cathode-side separator when the second catalyst layer is the cathode catalyst layer. The second separator is the anode-side separator when the second catalyst layer is the anode catalyst layer.

The first separator and the second separator are collectively referred to as “separator”. The anode-side separator and the cathode-side separator are collectively referred to as “separator”.

The membrane electrode gas diffusion layer assembly is sandwiched by the first separator and the second separator.

The separator may include supply and discharge holes for allowing the fluid such as the reaction gas and the refrigerant to flow in the stacking direction of the unit fuel cells. When the refrigerant is gas, for example, cooling air may be used as the refrigerant. When the refrigerant is liquid, to prevent freezing at low temperature, cooling water such as a mixed solution of ethylene glycol and water may be used as the refrigerant, for example.

As the supply hole, examples include, but are not limited to, a fuel gas supply hole, an oxidant gas supply hole, and a refrigerant supply hole.

As the discharge hole, examples include, but are not limited to, a fuel gas discharge hole, an oxidant gas discharge hole, and a refrigerant discharge hole.

The separator may include one or more fuel gas supply holes, one or more oxidant gas supply holes, one or more refrigerant supply holes as needed, one or more fuel gas discharge holes, one or more oxidant gas discharge holes, and one or more refrigerant discharge holes as needed.

The separator may include a reaction gas flow path on a surface in contact with the gas diffusion layer. Also, the separator may include a refrigerant flow path for keeping the temperature of the fuel cell constant, on the surface opposite to the surface in contact with the gas diffusion layer.

When the separator is the anode-side separator, it may include one or more fuel gas supply holes, one or more oxidant gas supply holes, one or more refrigerant supply holes as needed, one or more fuel gas discharge holes, one or more oxidant gas discharge holes, and one or more refrigerant discharge holes as needed. The anode-side separator may include a fuel gas flow path for allowing the fuel gas to flow from the fuel gas supply hole to the fuel gas discharge hole, on the surface in contact with the anode-side gas diffusion layer. As needed, the anode-side separator may include a refrigerant flow path for allowing the refrigerant to from the refrigerant supply hole to the refrigerant discharge hole, on the surface opposite to the surface in contact with the anode-side gas diffusion layer.

When the separator is the cathode-side separator, it may include one or more fuel gas supply holes, one or more oxidant gas supply holes, one or more refrigerant supply holes as needed, one or more fuel gas discharge holes, one or more oxidant gas discharge holes, and one or more refrigerant discharge holes as needed. The cathode-side separator may include an oxidant gas flow path for allowing the oxidant gas to flow from the oxidant gas supply hole to the oxidant gas discharge hole, on the surface in contact with the cathode-side gas diffusion layer. As needed, the cathode-side separator may include a refrigerant flow path for allowing the refrigerant to flow from the refrigerant supply hole to the refrigerant discharge hole, on the surface opposite to the surface in contact with the cathode-side gas diffusion layer.

The separator may be a gas-impermeable electroconductive member or the like. As the electroconductive member, examples include, but are not limited to, a resin material such as thermosetting resin, thermoplastic resin and resin fiber, a carbon composite material obtained by press-molding a carbonaceous material such as carbon powder and carbon fiber, gas-impermeable dense carbon obtained by carbon densification, and a metal plate (such as a titanium plate, an iron plate, an aluminum plate and a stainless-steel (SUS) plate) obtained by press-molding. The separator may function as a collector.

The fuel cell may include a manifold such as an inlet manifold communicating between the supply holes and an outlet manifold communicating between the discharge holes.

As the inlet manifold, examples include, but are not limited to, an anode inlet manifold, a cathode inlet manifold and a refrigerant inlet manifold.

As the outlet manifold, examples include, but are not limited to, an anode outlet manifold, a cathode outlet manifold and a refrigerant outlet manifold.

In the present disclosure, the fuel gas and the oxidant gas are collectively referred to as “reaction gas”. The reaction gas supplied to the anode is the fuel gas, and the reaction gas supplied to the cathode is the oxidant gas. The fuel gas is a gas mainly containing hydrogen, and it may be hydrogen. The oxidant gas may be oxygen, air, dry air or the like.

The fuel cell may include a resin frame.

The resin frame may be disposed in the periphery of the membrane electrode gas diffusion layer assembly and may be disposed between the first separator and the second separator.

The resin frame may be a component for preventing cross leakage or a short circuit between the catalyst layers of the membrane electrode gas diffusion layer assembly.

The resin frame may include a skeleton, an opening, supply holes and discharge holes.

The skeleton is a main part of the resin frame, and it connects to the membrane electrode gas diffusion layer assembly.

The opening is a region retaining the membrane electrode gas diffusion layer assembly, and it is also a through-hole penetrating a part of the skeleton to set the membrane electrode gas diffusion layer assembly therein. In the resin frame, the opening may be disposed in the position where the skeleton is disposed around (in the periphery) of the membrane electrode gas diffusion layer assembly, or it may be disposed in the center of the resin frame.

The supply and discharge holes allows the reaction gas, the refrigerant and the like to flow in the stacking direction of the unit fuel cells. The supply holes of the resin frame may be aligned and disposed to communicate with the supply holes of the separator. The discharge holes of the resin frame may be aligned and disposed to communicate with the discharge holes of the separator.

The resin frame may include a frame-shaped core layer and two frame-shaped shell layers disposed on both surfaces of the core layer, that is, a first shell layer and a second shell layer.

Like the core layer, the first shell layer and the second shell layer may be disposed in a frame shape on both surfaces of the core layer.

The core layer may be a structural member which has gas sealing properties and insulating properties. The core layer may be formed of a material such that the structure is unchanged at the temperature of hot pressing in a fuel cell production process. As the material for the core layer, examples include, but are not limited to, resins such as polyethylene, polypropylene, polycarbonate (PC), polyphenylene sulfide (PPS), polyethylene terephthalate (PET), polyethylene naphthalate (PEN), polyamide (PA), polyimide (PI), polystyrene (PS), polyphenylene ether (PPE), polyether ether ketone (PEEK), cycloolefin, polyethersulfone (PES), polyphenylsulfone (PPSU), liquid crystal polymer (LCP) and epoxy resin. The material for the core layer may be a rubber material such as ethylene propylene diene rubber (EPDM), fluorine-based rubber and silicon-based rubber.

From the viewpoint of ensuring insulating properties, the thickness of the core layer may be 5 μm or more, or it may be 30 μm or more. From the viewpoint of reducing the cell thickness, the thickness of the core layer may be 200 μm or less, or it may be 150 μm or less.

To attach the core layer to the anode-side and cathode-side separators and to ensure sealing properties, the first shell layer and the second shell layer may have the following properties: the first and second shell layers have high adhesion to other substances; they are softened at the temperature of hot pressing; and they have lower viscosity and lower melting point than the core layer. More specifically, the first shell layer and the second shell layer may be thermoplastic resin such as polyester-based resin and modified olefin-based resin, or they may be thermosetting resin such as modified epoxy resin. The first shell layer and the second shell layer may be the same kind of resin as the adhesive layer.

The resin for forming the first shell layer and the resin for forming the second shell layer may be the same kind of resin, or they may be different kinds of resins. By disposing the shell layers on both surfaces of the core layer, it becomes easy to attach the resin frame and the two separators by hot pressing.

From the viewpoint of ensuring adhesion, the thickness of the first and second shell layers may be 5 μm or more, or it may be 20 μm or more. From the viewpoint of reducing the cell thickness, the thickness of the first and second shall layers may be 100 μm or less, or it may be 40 μm or less.

In the resin frame, the first shell layer may be disposed only at a part that is attached to the anode-side separator, and the second shell layer may be disposed only at a part attached to the cathode-side separator. The first shell layer disposed on one surface of the core layer may be attached to the cathode-side separator. The second shell layer disposed on the other surface of the core layer may be attached to the anode-side separator. The resin frame may be sandwiched by the pair of separators.

The gasket comprises the first convexity having a height larger than the thickness of the cooling plate, and the gasket seals the manifolds of the adjacent unit fuel cells. Accordingly, such a structure is obtained, that the cooling plate does not appear on the manifold, and the cooling plate is not in contact with the reaction gas such as the oxidant gas and the fuel gas.

That is, the gasket is disposed between the adjacent unit fuel cells and seals the periphery of the manifolds of the adjacent unit fuel cells so that the cooling plate is isolated from the manifold and the reaction gas flowing through the manifold is prevented from leaking to the region where the cooling plate is disposed. Accordingly, the manifold allows the reaction gas to flow only in the stacking direction in the region between the adjacent unit fuel cells, and it can prevent the reaction gas from leaking in the planar direction.

When there are several manifolds, one gasket may be disposed in each manifold to seal the manifold, or one plate-shaped gasket having such a structure that can seal the manifolds, may be disposed. Of the manifolds, no gasket may be disposed in the refrigerant inlet manifold and the refrigerant outlet manifold, and the refrigerant inlet and outlet manifolds may communicate with the cooling plate and the refrigerant flow path of the separator.

At least at a part of the side portion of the first convexity, the gasket comprises the second convexity comprising the convexity in the same direction as the first convexity (i.e., a side lip). The second convexity may be disposed at least at a part of the side portion of the first convexity; it may be disposed at the complete periphery of the side portion; or it may be disposed in a region accounting for 50% of the perimeter of the gasket. The second convexity may be disposed in the region accounting for 50% of the perimeter of the gasket at the side portion of the first convexity and the region on the side opposite to the side on which the MEGA is disposed in the planar direction, that is, the second convexity may be disposed in the region on the outer side of the unit fuel cell. Accordingly, torsion of the separator is less likely to occur in the inside region in the planar direction of the unit fuel cell, resulting in a reduction of production cost.

By disposing the side lip, the side lip is compressed, and a cell seal line beneath the gasket is always compressed and is less likely to be detached. By the side lip, torsion and rapture of the separator is suppressed. This suppression of the torsion of the separator was confirmed from the results of calculation by the finite element method (FEM).

The height of the second convexity may be the same as, higher than or lower than the height of the first convexity. The height of the second convexity may be equal to or lower than the height of the first convexity, or the height of the second convexity may be lower than the height of the first convexity.

The material for the gasket may be ethylene propylene diene monomer (EPDM) rubber, silicon rubber, thermoplastic elastomer resin or the like.

The height of the gasket may be larger than 50% of the thickness of a unit fuel cell-cooling plate assembly including one unit fuel cell and one cooling plate.

The thickness of the unit fuel cell means the total thickness of the first separator, the resin frame housing the MEGA in its opening, and the second separator.

The cooling plate is disposed between the adjacent unit fuel cells.

As long as the cooling plate is disposed between the adjacent unit fuel cells, the cooling plate may be disposed in at least a part of the region in the planar direction between the adjacent unit fuel cells.

The cooling plate may be disposed in the region which is between the unit fuel cells adjacent to each other in the planar direction and which faces at least the MEGA.

The cooling plate may be disposed in a region which is other than the region where the gasket is disposed between the unit fuel cells adjacent to each other in the planar direction.

The cooling plate may be disposed in a region which is other than the region where the gasket is disposed between the unit fuel cells adjacent to each other in the planar direction, and it may be disposed in a region excluding the outer peripheral edge portion in the planar direction between the adjacent unit fuel cells. That is, the cooling plate may be disposed between the adjacent unit fuel cells so that the end portions in the planar direction of the cooling plate do not reach the end portions in the planar direction of the unit fuel cells.

The cooling plate may be disposed in a region which is other than the region where the gasket is disposed between the unit fuel cells adjacent to each other in planar direction and which faces the MEGA.

The cooling plate is a corrugated plate including concave grooves configured to function as a refrigerant flow path.

Cooling water or cooling air may flow through the refrigerant flow path, or cooling air may flow through the refrigerant flow path. The volume of the refrigerant flow path can be increased by the cooling plate. Accordingly, an enough volume can be ensured when the refrigerant is air. When the refrigerant is liquid, the capacity of a cooling pump can be decreased, and pressure loss can be reduced.

As the cooling plate, for example, a corrugated metal plate obtained by folding a metal plate (such as an aluminum plate) may be used. The surface of the cooling plate may be subjected to conductive treatment with silver, nickel, carbon or the like.

The concave grooves of the cooling plate may be formed by folding the cooling plate.

The depth of the concave grooves may be from 1.0 mm to 2.0 mm, for example.

The metal plate may be folded to form concave grooves with a depth of from 1.0 mm to 2.0 mm at a pitch of from 1.0 mm to 2.0 mm, for example, thereby preparing the corrugated cooling plate.

FIG. 1 is an exploded perspective view of an example of a part of the fuel cell of the present disclosure.

The fuel cell includes an assembly 100 including a unit fuel cell 90, a cooling plate 50 and a gasket 60.

The unit fuel cell 90 includes a first separator 20, a resin frame 40 in which a MEGA is disposed in its opening, and a second separator 30 in this order.

The cooling plate 50 is disposed in a region which is other than the region where the gasket 60 is disposed on a surface of the second separator 30 of the unit fuel cell 90, and which faces the MEGA.

The gaskets 60 are disposed around manifolds 80 on the cooling plate 50-side surface of the second separator 30.

In the first separator 20, the resin frame 40 and the second separator 30, an oxidant gas supply hole, an oxidant gas discharge hole, a fuel gas supply hole and a fuel gas discharge hole are disposed, all of which are the manifolds 80 through which reaction air (oxidant gas) and hydrogen (fuel gas) can flow as indicated by arrows.

In the cooling plate 50, concave grooves are disposed, all of which serve as a refrigerant flow path through which cooling air (refrigerant) can flow as indicated by arrows.

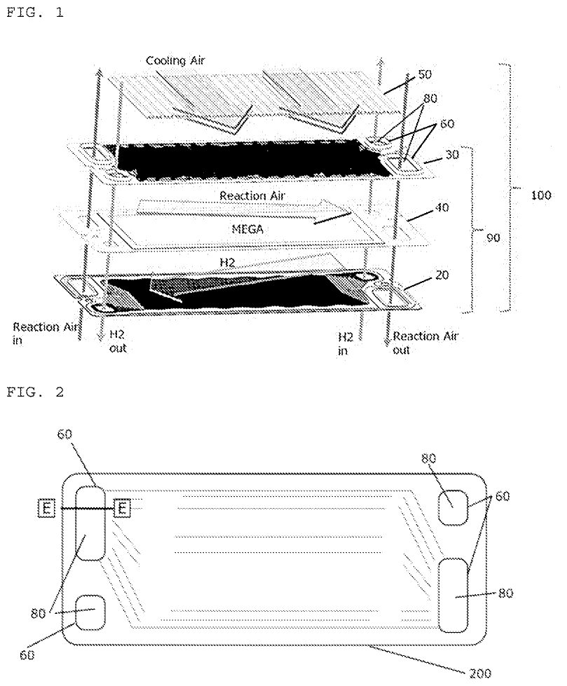

FIG. 2 is a plan view of an example of the fuel cell of the present disclosure.

A gasket 60 and a manifold 80 are disposed in a fuel cell 200.

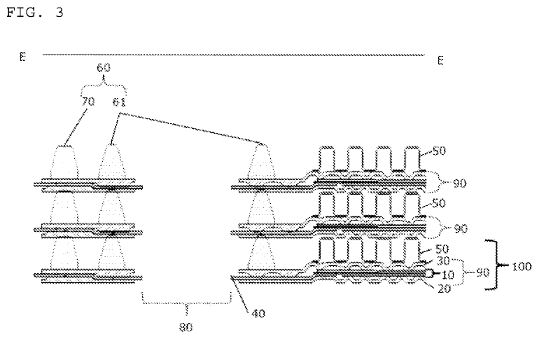

FIG. 3 is a sectional view of the fuel cell shown in FIG. 2 along the line E-E.

The fuel cell 200 is formed of stacked unit fuel cells 90.

The fuel cell 200 includes the unit fuel cells 90, cooling plates 50 disposed between the unit fuel cells 90 which are adjacent to each other, and a gasket 60.

The fuel cell includes an assembly 100 which includes a unit fuel cell 90, a cooling plate 50 and a gasket 60.

The unit fuel cell 90 includes a first separator 20, a resin frame 40 housing a MEGA 10 in its opening, and a second separator 30 in this order.

The cooling plate 50 is disposed in a region which is other than the region where the gasket 60 is disposed between the second separator 30 of one of the adjacent unit fuel cells 90 and the first separator 20 of the other unit fuel cell 90, and which faces the MEGA.

The gasket 60 is disposed in the periphery of the manifold 80 in the region between the second separator 30 of one of the adjacent unit fuel cells 90 and the first separator 20 of the other unit fuel cell 90.

The gasket 60 includes a first convexity 61, and it includes a second convexity 70 in at least a part of the periphery on the side opposite to the MEGA 10 of the first convexity 61 in the planar direction.

An example of the method for producing the fuel cell of the present disclosure, is as follows.

First and second separators (for example, flow path groove depth: 0.3 mm) are prepared by press-molding a carbon resin composite material.

In the periphery of the manifold on one surface of the first separator, a gasket (made of EPDM rubber or silicon rubber) is formed. The gasket may be attached to the second separator, or a gasket may be formed on a mold and transferred onto the separators, without forming the gasket on the separators.

A resin frame is prepared as follows: a sheet obtained by coating PEN with adhesive thermoplastic resin (for example, thickness 0.20 μm) is cut into a frame shape, and the frame-shaped sheet is used as the resin frame.

A membrane electrode gas diffusion layer assembly is prepared by stacking a first gas diffusion layer, a first catalyst layer, an electrolyte membrane, a second catalyst layer and a second gas diffusion layer are stacked in this order, and the stack thus obtained is used as the membrane electrode gas diffusion layer assembly.

At the end portion of the rectangular membrane electrode gas diffusion layer assembly, the frame-shaped resin frame and the membrane electrode gas diffusion layer assembly are attached with an adhesive, thereby obtaining a resin frame-MEGA assembly. The resin frame-MEGA assembly is sandwiched by the first and second separators so that a surface of the first separator, which is opposite to the surface on which the gasket is formed, is in contact with the resin frame-MEGA assembly. Next, a second separator-resin frame-MEGA-first separator assembly is obtained by welding the first separator and the resin frame together and welding the second separator and the resin frame together, both by hot pressing. Accordingly, a unit fuel cell is obtained, which includes the second separator, the resin frame housing the MEGA in its opening, and the first separator in this order.

An aluminum sheet (thickness 0.10 mm) plated with Ag (50 nm) is folded to form concave grooves (depth 1.5 mm) at a pitch of 1.5 mm, for example, thereby preparing a corrugated cooling plate.

The cooling plate is disposed on a surface of the first separator of the unit fuel cell, which is opposite to the surface in contact with the MEGA. The adhesive is disposed at the first separator-side four corners of the cooling plate, and the first separator and the cooling plate are attached to each other. Accordingly, an assembly in which the cooling plate and the gasket are disposed on the surface of the first separator of the unit fuel cell, is obtained.

Next, another unit fuel cell is prepared; the adhesive is disposed at the second separator-side four corners of the unit fuel cell of the cooling plate of the assembly; and the second separator of the unit fuel cell and the cooling plate are attached to each other. Accordingly, a fuel cell in which the cooling plate and the gasket are disposed between the adjacent unit fuel cells, is obtained. In the same manner, a stack may be obtained by stacking the unit fuel cells so that the cooling plates and the gaskets are disposed between the adjacent unit fuel cells. As needed, a collector plate and a pressure plate may be disposed in this order at the both end of the stack, thereby obtaining a fuel cell (a fuel cell stack).

### REFERENCE SIGNS LIST

10. MEGA

20. First separator

30. Second separator

40. Resin frame

50. Cooling plate

60. Gasket

61. First convexity

70. Second convexity

80. Manifold

90. Unit fuel cell

100. Assembly

200. Fuel cell

1. A fuel cell comprising:
unit fuel cells adjacent to each other,
a cooling plate, and
a gasket,
wherein the cooling plate is disposed between the adjacent unit fuel cells;
wherein the cooling plate is a corrugated plate comprising concave grooves configured to function as a refrigerant flow path;
wherein the gasket comprises a first convexity having a height larger than a thickness of the cooling plate, and the gasket seals manifolds of the adjacent unit fuel cells; and
wherein, at least at a part of a side portion of the first convexity, the gasket comprises a second convexity comprising a convexity in the same direction as the first convexity.

2. The fuel cell according to claim 1, wherein a height of the second convexity is equal to or lower than the height of the first convexity.

3. The fuel cell according to claim 1, wherein cooling water or air flows through the refrigerant flow path.
